(19) United States
(12) Patent Application Publication
(10) Pub. No.: US 2026/0291872 A1
(43) Pub. Date: Sep. 24, 2026

(54) METHODS AND APPARATUS FOR NETWORK MANAGEMENT

(71) Applicant: Telefonaktiebolaget LM Ericsson (publ), Stockholm (SE)

(72) Inventor: Miguel Angel MUÑOZ DE LA TORRE ALONSO, Madrid (ES)

(21) Appl. No.: 19/469,543

(22) PCT Filed: Apr. 27, 2023
(86) PCT No.: PCT/EP2023/061096

§ 371 Date: Sep. 26, 2025

(30) Foreign Application Priority Data
Mar. 27, 2023 (EP) 23382284.0

(51) Int. Cl. H04L 47/20; H04L 67/141; H04L 67/56

(52) U.S. Cl. CPC H04L 47/20; H04L 67/141; H04L 67/56

(57) ABSTRACT

A method and apparatus for traffic management in dual proxy deployment communication networks. The method includes retrieving and storing by a first function acting as an ingress proxy dual proxy rules associated with a UE ID, and generating by the first function an associated traffic correlation identifier based on the dual proxy rules. The method also includes transmitting by the first function via an egress proxy the associated traffic correlation identifier to an AS, transmitting by the AS a request to apply traffic management actions to the first function, wherein the request includes the associated traffic correlation identifier, and performing, by the first function and based on the associated traffic correlation identifier, a traffic management action.

### TECHNICAL FIELD

Embodiments of the present disclosure relate to methods and apparatus in communication networks, and particularly methods and apparatus for traffic management in dual proxy deployment communication networks.

### BACKGROUND

Fifth Generation (5G) and Fourth Generation (4G) New Radio (NR) cellular networks may use methods of traffic encryption in order to improve the security of the network. Over time, networks and traffic encryption mechanisms have increased in complexity. For example, many applications in 4G and 5G NR cellular networks are based on Hypertext Transfer Protocol Secure (HTTPS) cleartext using Transport Layer Security (TLS) encryption mechanisms. Additionally, traffic may be based on QUIC transport, which has a higher encryption level than TLS. In the future, it is anticipated that the percentage of applications based on QUIC transport will increase.

QUIC is a User Datagram Protocol (UDP) based stream-multiplexed and secure transport protocol with integrity protected headers and encrypted payloads. Unlike the traditional transport protocol stack with Transmission Control Protocol (TCP), which resides in the operating system kernel, QUIC is implemented in the application layer. This may improve flexibility in terms of transport protocol evolution with implementation of new features, congestion control, deploy ability and adoption. Further, compared to HTTPS, encryption in QUIC covers both the transport protocol headers as well as the payload, as opposed to TLS over TCP, e.g. HTTPS, which protects only the payload.

FIG. 1 depicts an overview of a 5G reference architecture comprising a Policy and Charging Control (PCC) framework. The network 101 of FIG. 1 includes a Unified Data Repository (UDR) 102. The UDR may store data grouped into distinct collections of subscription-related information. The subscription-related information may comprise: subscription data, policy data, structured data for exposure, and/or application data.

The network 101 of FIG. 1 further includes a Network Exposure Function (NEF) 103. The NEF may support different functionalities, such as different Exposure Application Programming Interfaces (APIs). Example APIs include NEF APIs for Quality of Service (QoS) and sponsored data. In some examples, the NEF may be a Packed Flow Description Function (PFDF). The network 101 also may include a Network Data Analytics Function (NWDAF) 104 and an Application Function (AF) 105.

The network 101 further includes a Policy Control Function (PCF) 106. The PCF may support a unified policy framework to govern the behaviour of the network. For example, the PCF may provide PCC rules to a Policy and Charging Enforcement Function (PCEF). In FIG. 1, the PCEF is implemented as part of the Session Management Function (SMF) 109 and the User Plane Function (UPF) 110. The SMF 109 may support different functionalities, for example by receiving PCC rules from the PCF and configuring the UPF 110 accordingly. The UPF may support the handling of user plane traffic, for example: packet inspection, packet routing and forwarding, traffic usage reporting, and/or QoS handling for the user plane (such as uplink (UL) and/or downlink (DL) rate enforcement). Further, the network 101 of FIG. 1 includes a Charging Function (CHF) 107 and Access and Mobility Function (AMF) 108.

Network operators may employ differentiated traffic management across the network. Accordingly, network operators may require application and/or service awareness in order to apply differentiated traffic management actions (for example, charging and Quality of Service management). Encryption methods such as dual proxy deployments may impact the ability of the network to access such information.

Dual proxy deployments are employed by many Mobile Network Operators (MNOs) as a form of private relay. Private relays are a form of internet privacy service built into an internet browser, which ensures all traffic leaving a User Equipment (UE) is encrypted. All user requests are sent through two separate relays. The first relay assigns the user an anonymous Internet Protocol (IP) address, for example that maps to a region associated with the user but not the exact location of the user. The second relay decrypts the web address requested by the user and forwards the user to their requested destination. This separation of information protects the user's privacy by ensuring no single entity can identify both the identity of the user and the identity of the requested destination.

Traffic Management is very important for MNOs. MNOs have built their offerings on the network capability to apply service differentiated charging and policy. MNOs allow for Content Providers to request different traffic management actions (e.g. QoS and Sponsored data related) through different northbound APIs (Nnef APIs). This is now challenged due to the raise of traffic encryption and in particular in dual proxy deployments, for which a MNO is not able to identify traffic and apply the corresponding traffic management actions.

### SUMMARY

It is an object of the present disclosure to facilitate traffic management in dual proxy deployment communication networks.

Embodiments of the disclosure aim to provide apparatuses and methods that alleviate some or all of the problems identified. In particular, embodiments of the disclosure aim to extend Nnef APIs with a correlation identifier, which allows a content provider or AF or Application Server (AS) to request traffic management actions in dual proxy deployments. Accordingly, embodiments of the disclosure aim to provide apparatuses and methods that allow content providers to request to MNO traffic management actions in dual proxy deployments in a simple and efficient way.

The present disclosure provides a method for traffic management in a dual proxy deployment network. The method comprises retrieving and storing by a first function acting as an ingress proxy dual proxy rules associated with a user equipment (UE) identification (ID). The method further comprises generating by the first function an associated traffic correlation identifier based on the dual proxy rules. The method further comprises transmitting by the first function via an egress proxy the associated traffic correlation identifier to an Application Server (AS). The method further comprises transmitting by the AS a request to apply traffic management actions to the first function, wherein the request includes the associated traffic correlation identifier. The method further comprises performing, by the first function and based on the associated traffic correlation identifier, a traffic management action.

The present disclosure also provides a dual proxy deployment network. The network comprises a first function acting as an ingress proxy dual proxy, the first function comprising processing circuitry and a non-transitory machine-readable medium storing instructions. The network further comprises an egress proxy comprising processing circuitry and a non-transitory machine-readable medium storing instructions, and an AS comprising processing circuitry and a non-transitory machine-readable medium storing instructions. The first function is configured to retrieve and store rules associated with a UE ID, generate an associated traffic correlation identifier based on the dual proxy rules, and transmit by the first function via the egress proxy the associated traffic correlation identifier to the AS. The AS is configured to transmit a request to apply traffic management actions to the first function, wherein the request includes the associated traffic correlation identifier. The first function is further configured to perform, based on the associated traffic correlation identifier, a traffic management action.

### BRIEF DESCRIPTION OF DRAWINGS

For a better understanding of the present disclosure, and to show how it may be put into effect, reference will now be made, by way of example only, to the accompanying drawings, in which:

FIG. 1 is a diagram of a 5G reference architecture;

FIG. 2 is a diagram of a dual proxy system in accordance with embodiments;

FIG. 3 is a flowchart of a method of traffic management, in accordance with embodiments; and

FIG. 4A, FIG. 4B, FIG. 4C, FIG. 4D, FIG. 4E, FIG. 4F, and FIG. 4G (collectively referred to as FIG. 4) is a sequence diagram of a further method of traffic management, in accordance with embodiments.

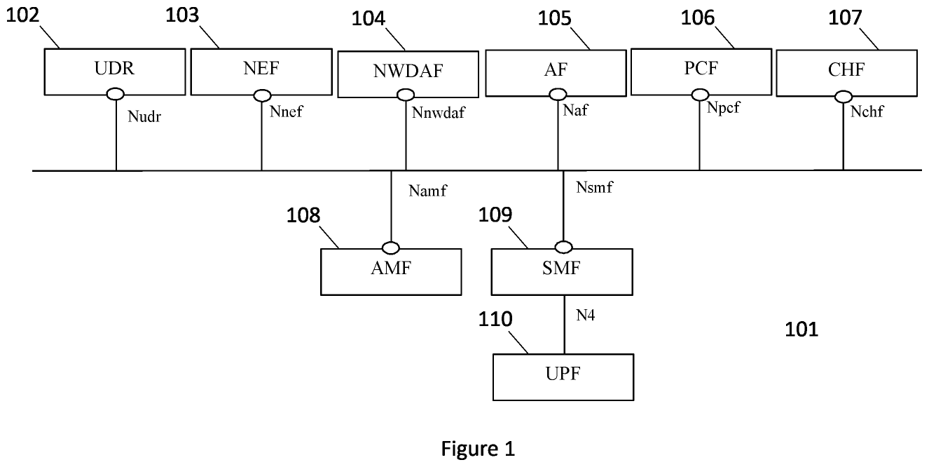

### DETAILED DESCRIPTION

The following sets forth specific details, such as particular embodiments for purposes of explanation and not limitation. It will be appreciated by one skilled in the art that other embodiments may be employed apart from these specific details. In some instances, detailed descriptions of well-known methods, nodes, interfaces, circuits, and devices are omitted so as to not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions. In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

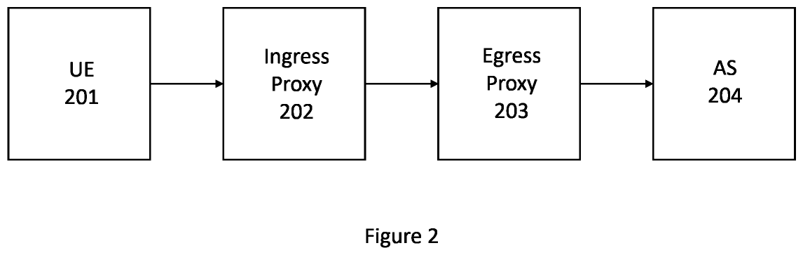

FIG. 2 depicts a private relay or dual proxy system suitable for implementing methods in accordance with embodiments. The private relay of FIG. 2 comprises a UE 201, an ingress proxy 202, an egress proxy 203, and an Application Server (AS) 204. The ingress proxy 202 may assign the user an anonymous IP address (for example, which maps to their region but not their actual location). The egress proxy 203 may decrypt the web address the user want to visit and forwards the user to their requested destination.

For a Multiplexed Application Substrate over QUIC Encryption (MASQUE) based dual-proxy deployment, the ingress proxy may be referred to as the first MASQUE proxy and the egress proxy may be referred to as the second MASQUE proxy. MASQUE mechanisms allow for the configuring and concurrently running multiple proxied stream-and datagram-based flows inside an HTTPS connection.

In general, a proxy is an intermediary program acting as both server and client, creating or simply relaying requests on behalf of other entities. Requests are serviced internally or by passing them on, with possible translation, to other servers. There are several types of proxies, including transparent proxies, non-transparent proxies, reverse proxies and Performance Enhancement Proxies (PEP).

A transparent proxy is a proxy that does not modify the request or response beyond what is required for proxy authentication and identification. A non-transparent proxy is a proxy that modifies the request or response to provide some added service to the user agent, such as group annotation services, media type transformation, protocol reduction, or anonymity filtering. A reverse proxy basically is a proxy that pretends to be the actual server (as far as any client or client proxy is concerned), but it passes on the request to the actual server that is usually sitting behind another layer of firewalls. A PEP is used to improve the performance of protocols on network paths where native performance suffers due to characteristics of a link or subnetwork on the path.

In the private relay or dual proxy system of FIG. 2, the ingress proxy 202 may be any one of a transparent proxy, a non-transparent proxy, a reverse proxy, or a PEP. Further, the egress proxy 203 may be any one of a transparent proxy, a non-transparent proxy, a reverse proxy, or a PEP.

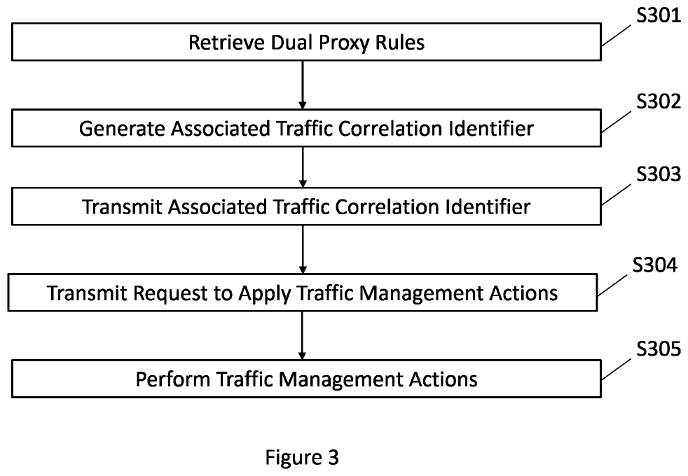

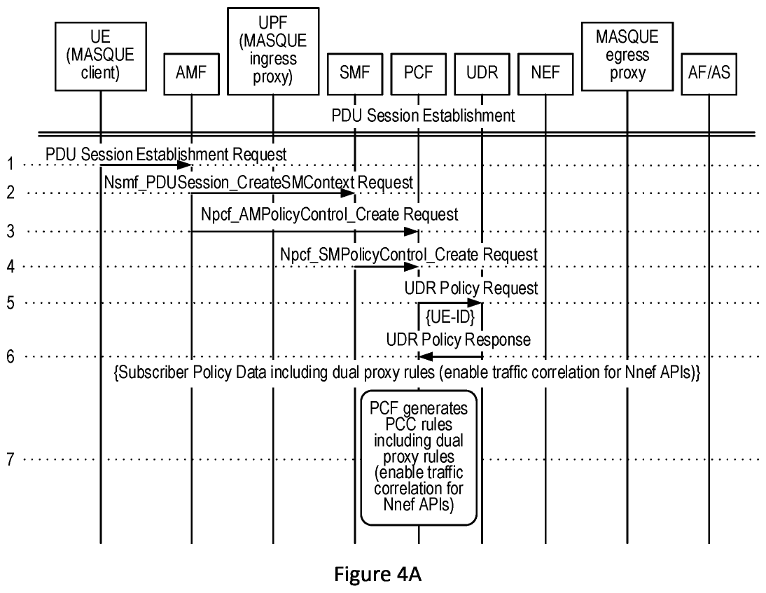

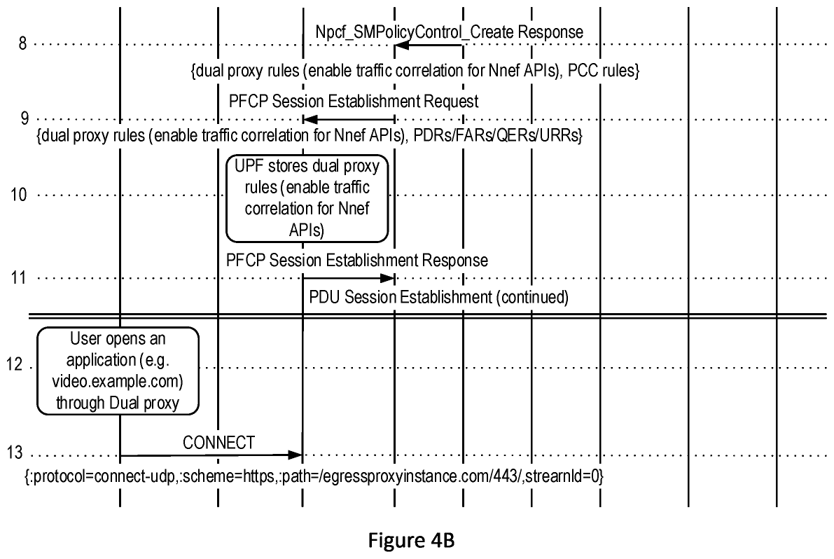

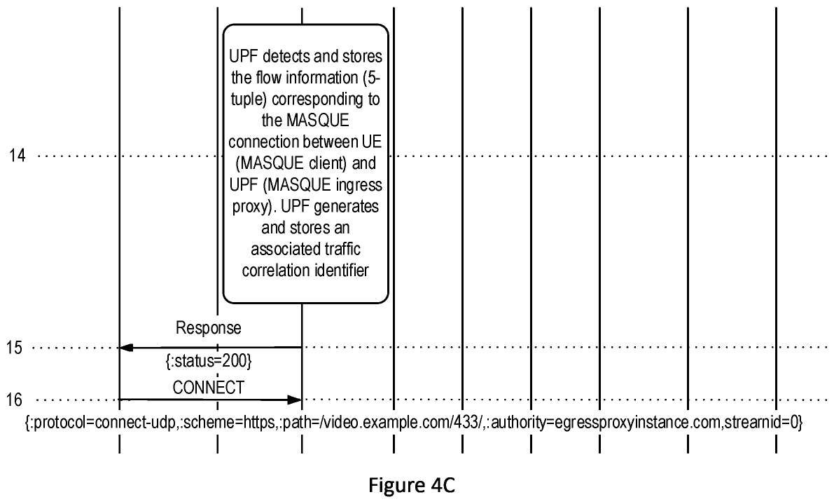

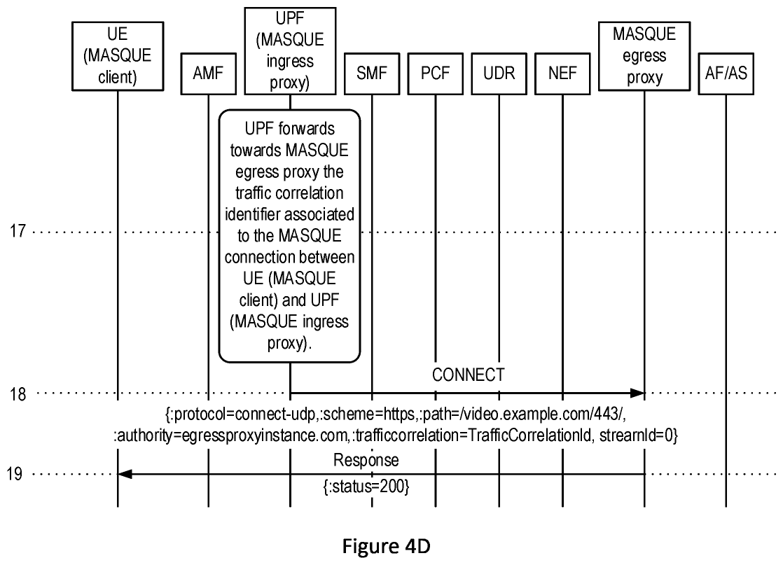

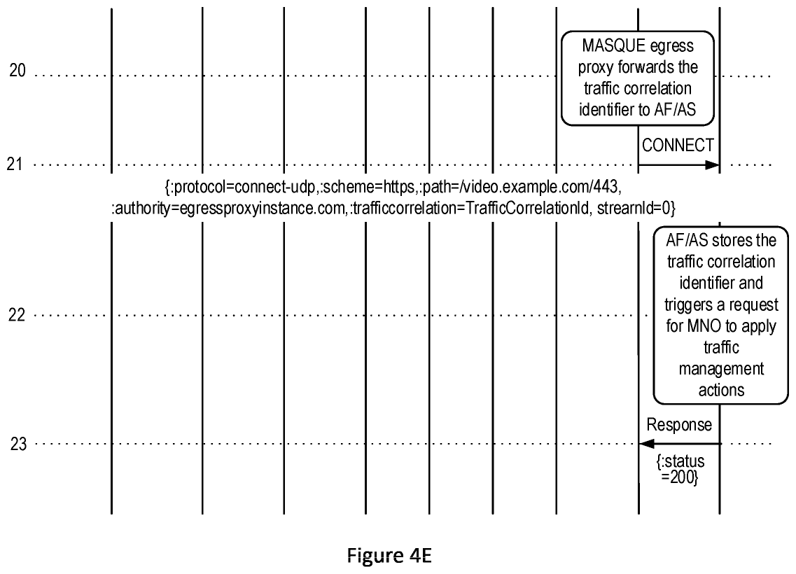

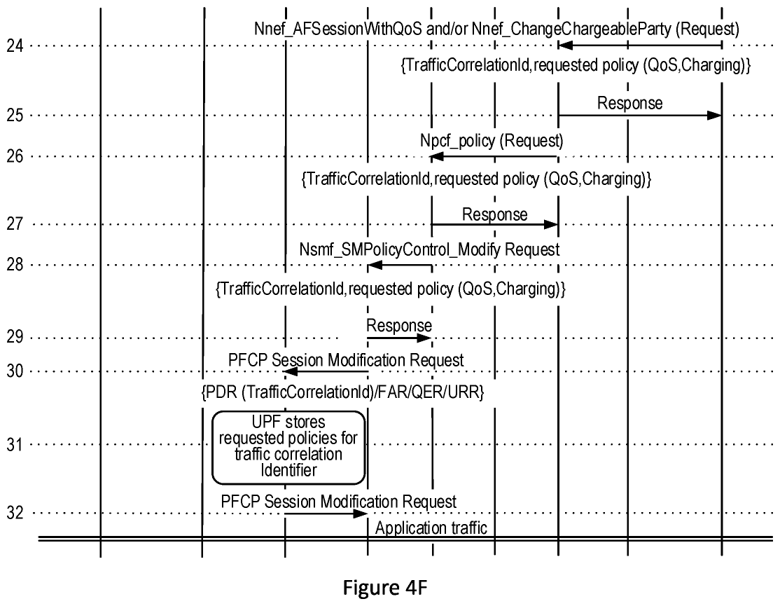

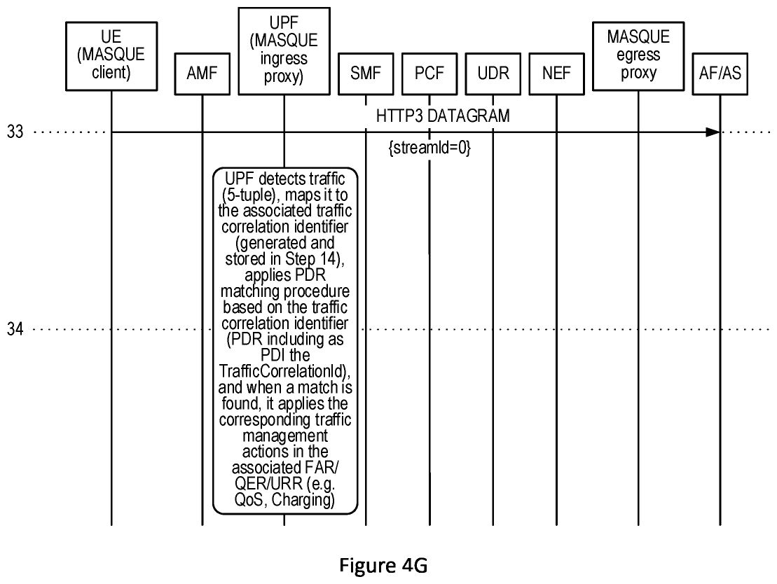

FIG. 3 is a flowchart of a method of traffic management in a dual proxy deployment communication network, in accordance with embodiments. As shown in Step S301 of FIG. 3, the method may comprise retrieving and storing by a first function acting as an ingress proxy dual proxy rules associated with a UE identification (ID). The dual proxy rules may comprise an indication to enable traffic correlation for Nnef APIs, as shown in Step 10 of FIG. 4.

In order to undertake this step, the method may comprise further steps as shown in FIG. 4. For example, as shown in FIG. 4, the method may comprise triggering by a UE a Protocol Data Unit (PDU) Session Establishment procedure (Steps 1-4 of FIG. 4). It will be appreciated by one skilled in the art that messages beyond what are described herein may be included in the method, and that only the messages relevant to the specific purpose of traffic management in the communication network will be described in detail.

In a more specific embodiment, the method may comprise transmitting by the UE a PDU Session Establishment request to an Access and Mobility Function (AMF), as shown in Step 1 of FIG. 4. The method may further comprise transmitting by the AMF a first request message to the second function, as shown in Step 2 of FIG. 4. As shown in the example of FIG. 4, the first request message may be a Nsmf_PDUSession_CreateSMContext Request message and the second function may be a Session Management Function (SMF).

The method may further comprise transmitting by the AMF a second request message to a Policy Function (PF), as shown in Step 3 of FIG. 4. As shown in the example of FIG. 4, the second request message may be a Npcf_AMPolicyControl_Create Request message and the PF may be a Policy Control Function (PCF).

The method may further comprise transmitting by the second function a third request message to the PF, as shown in Step 4 of FIG. 4. As shown in the example of FIG. 4, the third request message may be a Npcf_SMPolicyControl_Create request message, the second function may be a SMF and the PF may be a Policy Control Function (PCF).

In specific embodiments, the method may further comprise retrieving by a Policy Function, PF, a subscriber policy associated with a UE ID, wherein the subscriber policy comprises the dual proxy rules. For example, the method may comprise transmitting by the PF a Repository Policy Request to a Repository (as shown in Step 5 of FIG. 4) and transmitting by the Repository a Repository Policy Response to the PF, wherein the Repository Policy Response comprises the subscriber policy (as shown in Step 6 of FIG. 4). As shown in FIG. 4, the PF may be a PCF, and the Repository may be a User Data Repository (UDR). Accordingly, as shown in FIG. 4, embodiments may include steps in which a PCF of a communication network retrieves from the UDR of said network the subscriber policy associated with a UE ID; this subscriber policy may include dual proxy rules, and more specifically may include an indication to enable traffic correlation for Nnef APIs.

The method may additionally comprise PCC rules generating by the PF using the dual proxy rules (as shown in Step 7 of FIG. 4), and transmitting the PCC rules to a second function by the PF (as shown in Step 8 of FIG. 4). As shown in the example of FIG. 4, the second function may be a SMF and the PF may be a PCF. Accordingly, as shown in FIG. 4, embodiments may include steps in which a PCF generates PCC rules including dual proxy rules, specifically an indication to enable traffic correlation for Nnef APIs.

Further, the method may comprise transmitting by the second function a Packet Flow Control Protocol (PFCP) Session Establishment procedure trigger to the first function to indicate a Packet Detection Rule (PDR) and corresponding enforcement actions, wherein the trigger comprises the dual proxy rules (as shown in Step 9 of FIG. 4). As shown in FIG. 4, the first function may be a User Plane Function (UPF) and may more specifically be a MASQUE ingress proxy. The second function may be a SMF. Accordingly, as shown in FIG. 4, embodiments may include steps in which the network SMF triggers a PFCP Session Establishment procedure towards the network UPF to indicate the relevant Packet Detection Rules (PDRs) and the corresponding enforcement actions for the PDU session. Specifically, the dual proxy rules may include an indication to enable traffic correlation for Nnef APIs. Corresponding enforcement actions may include one or more of: Forwarding Action Rules (FAR), Usage Reporting Rules (URR) and QoS Enforcement Rules (QER). Additional traffic management actions may comprise one or more of: maintaining a QoS above a minimum threshold, traffic steering, monitoring how to charge subscriber's data, controlling charging of subscriber's data, and monitoring and/or controlling sponsored data.

Additionally, the method may include transmitting by the first function a PFCP Session Establishment Response to the second function (as shown in Step 11 of FIG. 4). As shown in FIG. 4, the first function may be a UPF and may more specifically be a MASQUE ingress proxy. The second function may be a SMF.

As shown in Step S302 of FIG. 3, the method may comprise generating by the first function an associated traffic correlation identifier based on the dual proxy rules. In specific embodiments, the method may comprise opening an application at the UE through dual-proxy deployment (as shown in Step 12 of FIG. 4), transmitting a HTTP CONNECT method to the first function by the UE (as shown in Step 13 of FIG. 4), and detecting and storing by the first function flow information corresponding to a connection between the UE and the first function (as shown in Step 14 of FIG. 4). As shown in FIG. 4, the first function may be a UPF.

Accordingly, by way of example and as shown in FIG. 4, specific embodiments may include steps in which a user at the UE opens an application (for example, video.example.com) through dual proxy deployment. The UE then sends a HTTP CONNECT method including the following information to the UPF:
protocol=connect−udp.
:scheme=https
:path=/egressproxyinstance.com/443/.
streamId=0

Based on the dual proxy rules (including, for example, an indication to enable traffic correlation for Nnef APIs) received and stored in Step S301 of the method, the first function (or, in more specific embodiments, the UPF) detects and stores the flow information (for example, in a 5-tuple format) corresponding to the connection between UE (client) and first function (ingress proxy). This connection may be a MASQUE connection between UE (MASQUE client) and UPF (MASQUE ingress proxy). The first function or UPF then generates and stores an associated traffic correlation identifier. Specific embodiments may also include a step of transmitting by the first function (or more specifically the UPF) a response indicating successful operation to the UE (as shown in Step 15 of FIG. 4).

As shown in Step S303 of FIG. 3, the method may comprise transmitting by the first function via an egress proxy the associated traffic correlation identifier to an AS or AF. For example, as shown in FIG. 4, in a network where the first function is a UPF (or more specifically a MASQUE ingress proxy) and the egress proxy is a MASQUE egress proxy, the UPF may forward towards the MASQUE egress proxy the traffic correlation identifier associated to the MASQUE connection between UE (MASQUE client) and UPF (MASQUE ingress proxy). This is shown as Step 17 and Step 18 in FIG. 4. The traffic correlation identifier may included in the CONNECT message towards the MASQUE egress proxy (for example, as :trafficcorrelation=TrafficCorrelationId), or alternatively it could be included in any other message (e.g. any HTTP request method) between the MASQUE ingress proxy and the MASQUE egress proxy.

Accordingly, as shown in Step 20 and Step 21 of FIG. 4, the MASQUE egress proxy may retrieve the traffic correlation identifier received from MASQUE ingress proxy and forwards it to the AF/AS. As depicted in FIG. 4, the traffic correlation identifier may be included in a CONNECT message towards the AF/AS (for example, as :trafficcorrelation=TrafficCorrelationId), or alternatively it could be included in any other message (e.g. any HTTP request method) between the MASQUE egress proxy and the AF/AS.

In order to undertake step S303, the method may comprise further steps as shown in FIG. 4. For example, as shown in FIG. 4, the method may comprise performing by the UE a CONNECT request to the egress proxy, wherein the CONNECT request is performed through a tunnel with the first function (as shown in Step 16 of FIG. 4). The method may also include transmitting by the egress proxy a response message to the UE indicating successful operation (as shown in Step 19 of FIG. 4). As shown in FIG. 4, the first function may be a MASQUE ingress proxy and the egress proxy may be a MASQUE egress proxy. More specifically, the first function may be a UPF.

As shown in Step S304 of FIG. 3, the method may comprise transmitting by the AS a request to apply traffic management actions to the first function, wherein the request includes the associated traffic correlation identifier. Such a message may be direct, or may be transmitted via other elements of the communication network.

For example, as shown in FIG. 4, in a network where the first function is a UPF (or more specifically a MASQUE ingress proxy), the method may comprise storing by the AS the associated traffic correlation identifier (as shown in Step 22 of FIG. 4). In specific embodiments, the method may also comprise transmitting by the AS a response message indicating successful operation to the egress proxy (as shown in Step 23 of FIG. 4). As shown in Step 24 of FIG. 4, the AS (or AF, in specific embodiments) may trigger a request for MNO to apply traffic management actions (e.g. QoS and/or Charging related), for example using the message Nnef_AFSessionWithQoS and/or Nnef_ChangeChargeableParty (Request). Further, said message may include the following information:
TrafficCorrelationId
Requested policy (QoS, Charging)

In specific embodiments, the request to apply traffic management actions to the first function may be sent via an Exposure Function (EF). The EF may be a Network Exposure Function (NEF) as shown in FIG. 4. As shown in Step 25 of FIG. 4, specific embodiments may comprise transmitting by the EF a message to the AS indicating successful operation.

In embodiments where the request to apply traffic management actions to the first function is sent to the first function via the EF, the method may further comprise updating a session policy at the EF. Alternatively or additionally, in embodiments where the request to apply traffic management actions to the first function is sent to the first function via the PF, the method may further comprise updating a session policy at the PF.

In specific embodiments, updating a session policy at the EF and/or the PF may comprise transmitting by the EF a fourth request message to the PF, wherein the request message comprises the associated traffic correlation identifier and the requested traffic management policy (as shown in Step 26 of FIG. 4). The method may also include transmitting by the PF an indication of successful operation to the EF in response to receipt of the fourth request message (as shown in Step 27 of FIG. 4). As shown in FIG. 4, the fourth request message may be a Npcf_Policy request message, the EF may be a NEF, and the PF may be a PCF. For example, the PCF may update the session policy by triggering a Npcf_Policy (Request) message including the following information:
TrafficCorrelationId
Requested policy (QoS, Charging, and so on).

Alternatively or additionally, updating a session policy at the EF and/or the PF may comprise transmitting by the PF a fifth request message to the second function, wherein the request message comprises the associated traffic correlation identifier and the requested traffic management policy (as shown in Step 28 of FIG. 4). The method may also include transmitting by the second function an indication of successful operation to the PF in response to receipt of the fifth request message (as shown in Step 29 of FIG. 4). As shown in FIG. 4, the fifth request message may be a Nsmf_SMPolicyControl_Modify request message, the PF may be a PCF, and the second function may be a SMF. For example, the SMF may update the session policy by triggering a Nsmf_SMPolicyControl_Modify Request message including the following information:
TrafficCorrelationId
Requested policy (QoS, Charging, and so on).

In some specific embodiments, the method may additionally comprise transmitting by the second function a PFCP Session Modification Request message to the first function, wherein the PFCP Session Modification Request message includes the associated traffic correlation identifier and a requested traffic management policy (as shown in Step 30 in FIG. 4) and storing by the first function the requested traffic management policy (as shown in Step 31 in FIG. 4). As depicted in FIG. 4, the second function may be a SMF, and the first function may be a UPF. Accordingly, in specific embodiments the method may comprise steps wherein the SMF of the network updates the PFCP session by triggering a PFCP Session Modification Request message including the following information:
PDR including as Packet Detection Information (PDI) the TrafficCorrelationId
Associated FAR/QER/URR including the requested policies (QoS, Charging, and so on).
   and the UPF stores requested policies for traffic correlation identifier. Specific embodiments may additionally comprise transmitting by the first function an indication of successful operation to the second function (as shown in Step 32 of FIG. 4).

As shown in Step S305 of FIG. 3, the method may comprise performing, by the first function and based on the associated traffic correlation identifier, a traffic management action. In order to undertake this step, the method may comprise further steps as shown in FIG. 4. For example, as shown in FIG. 4, specific embodiments may include transmitting by the UE a Hypertext Transfer Protocol over QUIC Encryption, HTPP3, datagram to the AS, and relaying end-to-end data between the UE and the AS via the first function and the egress proxy (as shown in Step 33 of FIG. 4). That is, in the specific embodiment of FIG. 4 the UE sends HTTP3 datagrams towards the AS/AF. End-to-end data may then be relayed via the MASQUE ingress proxy to the MASQUE egress proxy and onwards to the target server.

In a further specific embodiment, as shown in Step 34 of FIG. 4, the first function may detect traffic (for example, in a 5-tuple format), map the traffic to the associated traffic correlation identifier, apply a PDR matching procedure based on the traffic correlation identifier (PDR including as PDI the TrafficCorrelationId), and when a match is found, apply the corresponding traffic management actions in the associated FAR/QER/URR (e.g. QoS, Charging). As shown in FIG. 4, the first function may be a UPF.

Although the example of FIG. 4 is discussed in the context of a 5G network architecture, an analogous procedure may be performed in a 4G network architecture where the RAN supports the required measurements. For example, in a suitable 4G network architecture the EF may be a Service Capability Exposure Function (SCEF), the Repository may be a Subscriber Profile Repository (SPR), the PF may be a Policy and Charging Rule Function (PCRF), the second function may be a Packet Gateway Control Plane (PGW-C) or a Traffic Detection Function Control Plane (TDF-C), and the first function may be a Packet Gateway User Plane (PGW-U) or a Traffic Detection Function User Plane (TDF-U). That is, in an analogous 4G network procedure, the 4G functionality equivalent to the 5G functionality discussed above may equate to replacing: the PCF with a PCRF, the SMF with a PGW-C or TDF-C, the UPF with a PGW-U or TDF-U, the UDR with a SPR, and the NEF with a SCEF.

It will be understood that the detailed examples outlined above are merely examples. According to embodiments herein, the steps may be presented in a different order to that described herein. Furthermore, additional steps may be incorporated in the method that are not explicitly recited above. For the avoidance of doubt, the scope of protection is defined by the claims.

1. A method for traffic management in a dual proxy deployment network comprising:
retrieving and storing by a first function acting as an ingress proxy dual proxy rules associated with a user equipment, UE, identification, ID;
generating by the first function an associated traffic correlation identifier based on the dual proxy rules;
transmitting by the first function via an egress proxy the associated traffic correlation identifier to an Application Server, AS;
transmitting by the AS a request to apply traffic management actions to the first function, wherein the request includes the associated traffic correlation identifier; and
performing by the first function and based on the associated traffic correlation identifier, a traffic management action.

2. The method of claim 1, wherein the dual proxy rules comprise an indication to enable traffic correlation for Northbound Application Programming Interfaces, Nnef APIs.

3. The method of claim 1, wherein retrieving by the first function dual proxy rules associated with the UE ID comprises:
retrieving by a Policy Function, PF, a subscriber policy associated with a UE ID, wherein the subscriber policy comprises the dual proxy rules;
generating by the PF Policy, Charging, and Control, PCC, rules using the dual proxy rules;
transmitting by the PF the PCC rules to a second function;
transmitting by the second function a Packet Flow Control Protocol, PFCP, Session Establishment procedure trigger to the first function to indicate a Packet Detection Rule, PDR, and corresponding enforcement actions, wherein the trigger comprises the dual proxy rules; and
transmitting by the first function a PFCP Session Establishment Response to the second function.

4. The method of claim 3, wherein retrieving by the PF the subscriber policy associated with the UE ID comprises:
transmitting by the PF a Repository Policy Request to a Repository;
transmitting by the Repository a Repository Policy Response to the PF, wherein the Repository Policy Response comprises the subscriber policy.

5. The method of claim 3, wherein the method further comprises:
transmitting by the second function a PFCP Session Modification Request message to the first function, wherein the PFCP Session Modification Request message includes the associated traffic correlation identifier and a requested traffic management policy;
storing by the first function the requested traffic management policy; and
transmitting by the first function an indication of successful operation to the second function.

6. The method of claim 1, wherein the method further comprises:
triggering by a UE a Protocol Data Unit, PDU, Session Establishment procedure.

7. The method of claim 5, wherein triggering by the UE the PDU Session Establishment procedure comprises:
transmitting by the UE a PDU Session Establishment request to an Access and Mobility Function, AMF;
transmitting by the AMF a first request message to the second function;
transmitting by the AMF a second request message to the PF; and
transmitting by the second function a third request message to the PF.

8. The method of claim 1, wherein the method further comprises:
opening an application at the UE through dual-proxy deployment;
transmitting by the UE a HTTP CONNECT method to the first function;
detecting and storing by the first function flow information corresponding to a connection between the UE and the first function; and
transmitting by the first function a response indicating successful operation to the UE.

9. The method of claim 1, wherein the method further comprises:
performing by the UE a CONNECT request to the egress proxy, wherein the CONNECT request is performed through a tunnel with the first function; and
transmitting by the egress proxy a response message to the UE indicating successful operation.

10. The method of claim 1, wherein the method further comprises:
storing by the AS the associated traffic correlation identifier; and
transmitting by the AS a response message indicating successful operation to the egress proxy.

11. The method of claim 1, wherein the request to apply traffic management actions to the first function is sent via an Exposure Function, EF, and the method further comprises:
transmitting by the EF a message to the AS indicating successful operation.

12. The method of claim 1, wherein the request to apply traffic management actions to the first function is sent to the first function via at least one of the EF and the PF, and wherein the method further comprises:
updating a session policy at the at least one of EF and the PF.

13. The method of claim 12, wherein updating a session policy at the EF and the PF comprises:
transmitting by the EF a fourth request message to the PF, wherein the request message comprises the associated traffic correlation identifier and the requested traffic management policy; and
transmitting by the PF a fifth request message to the second function, wherein the request message comprises the associated traffic correlation identifier and the requested traffic management policy; and optionally further comprising transmitting by the PF an indication of successful operation to the EF in response to receipt of the fourth request message; and
transmitting by the second function an indication of successful operation to the PF in response to receipt of the fifth request message.

14. The method of claim 1, wherein the method further comprises:
transmitting by the UE a Hypertext Transfer Protocol over QUIC Encryption, HTPP3, datagram to the AS; and
relaying end-to-end data between the UE and the AS via the first function and the egress proxy.

15. The method of claim 1, wherein the traffic management actions comprise one or more of: maintaining a Quality of Service (QoS) above a minimum threshold, traffic steering, monitoring how to charge subscriber's data, controlling charging of subscriber's data, and monitoring and/or controlling sponsored data.

16. The method of claim 1, wherein the first function acts as a Multiplexed Application Substrate over QUIC Encryption, MASQUE, ingress proxy and the egress proxy is a MASQUE egress proxy.

17. The method of claim 1, wherein the EF is a Network Exposure Function, NEF, the Repository is a User Data Repository, UDR, the PF is a Policy Control Function, PCF, the second function is a Session Management Function, SMF, and the first function is a User Plane Function, UPF.

18. The method of claim 17, wherein the first Request message is a Nsmf_PDUSession_CreateSMContext Request message, the second Request message is a Npcf_AMPolicyControl_Create Request message, and the third Request message is a Npcf_SMPolicyControl_Create request message.

19. The method of claim 17, wherein the fourth request message is a Npcf_Policy request message and the fifth request message is a Nsmf_SMPolicyControl_Modify request message.

20. (canceled)

21. A dual proxy deployment network, the network comprising a first function acting as an ingress proxy dual proxy, the first function comprising processing circuitry and a non-transitory machine-readable medium storing instructions, an egress proxy comprising processing circuitry and a non-transitory machine-readable medium storing instructions, and an Application Server (204), AS, comprising processing circuitry and a non-transitory machine-readable medium storing instructions;
the first function being configured to retrieve and store rules associated with a user equipment UE, identification, ID, generate an associated traffic correlation identifier based on the dual proxy rules, and transmit by the first function via the egress proxy the associated traffic correlation identifier to the AS;
the AS being configured to transmit a request to apply traffic management actions to the first function, wherein the request includes the associated traffic correlation identifier; and
the first function being further configured to perform, based on the associated traffic correlation identifier, a traffic management action.

22.-40. (canceled)
